(19) United States
(12) Patent Application Publication
(10) Pub. No.: US 2005/0111373 A1
(43) Pub. Date: May 26, 2005

(54) Node device

(76) Inventors: Shinji Hiyama, Kawasaki (JP); Yasushi Nishine, Kawasaki (JP)

Correspondence Address: KATTEN MUCHIN ZAVIS ROSENMAN, 575 MADISON AVENUE, NEW YORK, NY, 10022-2585, US

(21) Appl. No.: 11/024,989

(22) Filed: Dec. 29, 2004

Related U.S. Application Data
(63) Continuation of application No. PCT/JP02/06644, filed on Jul. 1, 2002.

(51) Int. Cl. H04L 1/00

(52) U.S. Cl. 370/248

(57) ABSTRACT

In a node device switching over a working system to a protection system at the time of a fault occurrence, a relative phase difference detector detects a relative phase difference of transmission delays of a working transmission line and a protection transmission line, a path error detector detects path errors on the transmission lines, and a main signal error calculator calculates errors of the main signals from the transmission lines, thereby specifying a position on which the fault has occurred based on the path errors and main signal error calculation results which are made in phase based on the relative phase difference.

### BACKGROUND OF THE INVENTION

1. Field of the Invention

The present invention relates to a node device, and in particular to a node device which switches over a working (current) system to a protection (standby) system at the time of a fault occurrence.

Together with recent communication developments, information has been increased in speed and capacity, and multimedialized. In a network transmitting such information, how fast a fault occurrence point is specified to recover the network is important for improving reliability and operability of the network.

2. Description of the Related Art

FIG. 10 shows a general network which adopts a ring switchover system. This network is provided with Add/Drop multiplexing conversion node devices (Add/Drop multiplexers: ADMs) 101 and 201, and relay node devices (hereinafter, occasionally referred to as THRU nodes) 300_1 and 300_2.

The Add/Drop multiplexing conversion node devices 101 and 201 are both provided with add/drop functions. FIG. 10 specifically shows a case where a signal is transmitted from the node device 101 to the node device 201. In the node device (hereinafter, occasionally referred to as ADD node) 101, only the add function is shown, and in the node device (hereinafter, occasionally referred to as DROP node) 201, only the drop function is shown.

The ADD node 101, the THRU node 300_1, the DROP node 201, and the THRU node 300_2 are connected in this order in a ring shape with outbound high-speed transmission lines (sections) 400_1-400_4 (hereinafter, occasionally represented by a reference numeral 400), and are connected in the reverse order in a ring shape with inbound high-speed transmission lines 500_1-500_4 (hereinafter, occasionally represented by a reference numeral 500).

The ADD node 101 is provided with a working low-speed interface 20_1, a protection low-speed interface 20_2, a selector 24, and an add functional portion 110. The drop node 201 is provided with a drop functional portion 210, a selector 41, a working low-speed interface 40_1, and a protection low-speed interface 40_2. Also, an operation terminal 700 is connected to the ADD node 101.

In the ADD node 101, main signals such as VC3/VC4/VC4-4C per path inputted from low-speed transmission lines 600_1 and 600_2 are respectively provided to the selector 24 through the low-speed interfaces 20_1 and 20_2.

The selector 24 selects the main signal from the working low-speed interface 20_1, and transmits the selected main signal to the outbound high-speed transmission line 400_1 and the inbound high-speed transmission line 500_1 through the add functional portion 110.

The main signal transmitted to the outbound high-speed transmission line 400_1 is transmitted to the DROP node 201 through the THRU node 300_1 and the transmission line 400_2. The main signal transmitted to the inbound high-speed transmission line 500_1 is transmitted to the DROP node 201 through the THRU node 300_2 and the inbound high-speed transmission line 500_2.

In the DROP node 201, the drop functional portion 210 provides the main signal demultiplexed from the transmission lines 400_2 and 500_2 to the selector 41. The selector 41 selects the main signal demultiplexed from the working transmission line 400_2 to be transmitted to low-speed transmission lines 600_3 and 600_4 through the working low-speed interface 40_1 and the protection low-speed interface 40_2.

Thus, the main signal inputted from the low-speed transmission line 600_1 is transmitted to the low-speed transmission line 600_3 through the working low-speed interface 20_1, the working transmission lines 400_1 and 400_2, and the working low-speed interface 40_1.

Also, the same main signal is transmitted to the low-speed transmission line 600_4 through the protection interface 40_2.

The DROP node 201 monitors a transmission quality per path. When an abnormality (signal deterioration or the like) occurs in the working high-speed transmission line 400_1 or 400_2, the DROP node 201 instructs the selector 41 to select the main signals through the protection high-speed transmission lines 500_1 and 500_2 with a good quality (without fault occurrence). Thus, it becomes possible to render a stable service with a good quality.

However, when an error due to an abnormality of the working low-speed interface 20_1 occurs in the main signal in the ADD node 101, the main signal including the error is transmitted to both of the working transmission line 400_1 and the protection transmission line 500_1.

Even if the selector 41 switches over the main signal passing through the transmission line 400_2 to the main signal passing through the transmission line 500_2 in the DROP node 201, the main signal error is to continue since the main signals passing through the transmission lines 500_1 and 500_2 also include errors. Also, this meaningless switchover seriously deteriorates the transmission quality.

Also the switchover of main signal extracting transmission lines due to a main signal delay (time lag from the ADD node 101 to the arrival at the DROP node 201) by an outbound/inbound transmission line length (working/protection transmission line length) continues to occur alternately, so that there is a possibility of inviting an increase of control communication traffic and a confusion of a maintenance operation by frequent switchover notifications to an operation system.

### SUMMARY OF THE INVENTION

It is accordingly an object of the present invention to provide a node device which switches over a working system to a protection system at the time of a fault occurrence, whereby it can be determined whether a fault which deteriorates a transmission quality has occurred either on the node device or a transmission line.

(1) In order to achieve the above-mentioned object, the node device (e.g. DROP node) according to the present invention comprises: a relative phase difference detector receiving main signals simultaneously transmitted from an opposed node device (e.g. ADD node) to a working transmission line and a protection transmission line and detecting a relative phase difference between both of the main signals; a path error detector detecting path errors on the transmission lines; and a transmitter transmitting the relative phase difference and the path (route) errors to the opposed node device (ADD node).

Namely, in FIG. 3, e.g. a DROP node 200 can transmit a “relative phase difference” and a “path error” to an opposed ADD node 100.

A relative phase difference detector 37 detects the relative phase difference of main signals simultaneously transmitted to a working transmission line 400 and a protection transmission line 500 from the ADD node 100. A path error detector detects path errors of both transmission lines, e.g. an error number of B3 byte of PHO (Path OverHead) in SDH (Synchronous Digital Hierarchy), and a transmitter transmits the relative phase difference and the path errors to the ADD node 100 by e.g. GI byte.

Thus, it becomes possible for the ADD node 100 to determine whether or not a fault has occurred in the working transmission line, the protection transmission line, or the node itself based on the relative phase difference and the path errors.

Namely, the ADD node 100 compares both of the path errors of in-phase based on the relative phase difference. For example, \mathring{1} when the path errors do not indicate “error”, the ADD node 100 determines that all of the working/protection transmission lines and the node itself are normal. \mathring{2} When one of the path errors indicates “error”, the ADD node 100 determines that a fault has occurred on the transmission line corresponding to the path error. \mathring{3} When the path errors indicate the same “error”, the ADD node 100 determines that a fault has occurred in the node itself.

Accordingly, since this determination is performed based on the path errors of in-phase, it becomes possible to eliminate a switchover error due to a transmission delay difference between the working and the protection transmission lines.

(2) Also, the present invention according to the above-mentioned invention may further comprise a main signal error calculator calculating errors of the main signals from the working transmission line and the protection transmission line, and the transmitter may transmit the relative phase difference, the path errors and main signal error calculation results to the opposed node device (ADD node).

Namely, in FIG. 3, it is possible for e.g. the DROP node 200 to transmit the “relative phase difference”, the “path errors”, and “main signal error calculation results” to the opposed ADD node 100.

The ADD node 100 simultaneously transmits the main signals to the working transmission line and the protection transmission line. In the DROP node 200 having received the main signals, the relative phase difference detector 37 detects the relative phase difference of both of the main signals.

A main signal error calculator performs an error calculation, e.g. a CRC calculation, of the main signals having received from the working transmission line and the protection transmission line, respectively. The path error detector detects the path errors on the working transmission line and the protection transmission line. The transmitter transmits the phase difference, two path errors and two main signal error calculation results to the opposed ADD node 100.

It becomes possible for the opposed ADD node 100 to determine whether or not a fault has occurred in the node itself based on these relative phase difference, path errors and main signal error calculation results.

It is to be noted that the main signal error calculator need not always calculate for determining whether or not the main signal is transmitted without errors, but may calculate for determining that two main signals are equal since the remainders of the two main signals by the CRC calculation are equal.

When the same errors occur in the two main signals, the CRC calculation results (remainders) of the two main signals assume the same.

(3) Also, a node device (e.g. DROP node 200) according to the present invention comprises: a relative phase difference detector receiving main signals simultaneously transmitted from an opposed node device (e.g. ADD node 100) to a working transmission line and a protection transmission line and detecting a relative phase difference between both of the main signals; a path error detector detecting path errors on the transmission lines; a fault detector detecting a fault based on the relative phase difference and the path errors; and a transmitter notifying the fault to the opposed node device (ADD node 100).

Namely, in FIG. 3, e.g. the DROP node 200 can detect a fault based on the “relative phase difference” and the “path errors”, and can notify the fault (e.g. transmission line fault, fault of the opposed ADD node) to the opposed ADD node 100.

In the same way as the above-mentioned invention as mentioned in above (1), the relative phase difference detector detects the phase difference, and the path error detector detects the path errors in both of the transmission lines. This invention is different from the above-mentioned invention as mentioned in above (1) in that the ADD node 100 does not determine the fault of the node itself but the fault detector detects the fault of e.g. the ADD node 100, and the transmitter notifies the fault to the ADD node 100.

Thus, it becomes possible for the ADD node 100 to recognize whether or not a fault has occurred in the node itself.

It is to be noted that when the ADD node 100 is also related to the switchover between the working transmission line and the protection transmission line in the network configuration for example, the fault detector of the DROP node 200 detects the fault of the working transmission line or the protection transmission line, notifying the fault to the ADD node 100. Thus, it becomes possible for the ADD node 100 to switch over between the working transmission line and the protection transmission line.

(4) Also, the present invention according to the above-mentioned invention may further comprise a main signal error calculator calculating errors of the main signals from the transmission lines, the fault detector may detect the fault based on the relative phase difference, the path errors and main signal error calculation results and the transmitter may notify the fault to the opposed node device (e.g. ADD node 100).

Namely, in FIG. 3, e.g. the DROP node 200 can determine a fault based on the “relative phase difference”, the “path errors”, and the “main signal error calculation results” for the opposed ADD node 100, and can notify the fault to the ADD node 100.

In the above-mentioned invention as mentioned in above (3), a main signal error calculator further calculates errors of the main signals from the working transmission line and the protection transmission line, the fault detector detects the fault of the ADD node 100, the working transmission line or the protection transmission line based on the relative phase difference, path errors, the main signal error calculation results, so that the transmitter notifies the fault to the ADD node 100.

Thus, the ADD node 100 can recognize the fault of the node itself.

(5) Also, in the present invention according to the above-mentioned invention, the transmitter may transmit the relative phase difference by using an unused portion of a path overhead.

(6) Also, a node device (e.g. ADD node 100) according to the present invention comprises: a receiver receiving a relative phase difference between a working transmission line and a protection transmission line transmitted from an opposed node device (e.g. DROP node 200) and path errors on the transmission lines; a delay controller matching phases of the path errors based on the relative phase difference; and a fault determiner determining whether or not a fault has occurred in the node itself based on the path errors in phase.

Namely, in FIG. 3, e.g. the ADD node 100 can determine a fault of the node itself based on the “relative phase difference” and the “path errors” transmitted from the opposed DROP node 200.

The receiver of the ADD node 100 receives the relative phase difference between the working transmission line and the protection transmission line transmitted from the DROP node 200 and the path errors of the transmission lines. A delay controller of the ADD node 100 matches the phases of both path errors based on the relative phase difference. The fault determiner of the ADD node 100 determines whether or not a fault has occurred in e.g. the working main signal transmitter of the node itself based on the path errors in phase.

Thus, it becomes possible for the ADD node 100 to determine that a fault has occurred in the node itself.

(7) Also, in the present invention according to the above-mentioned invention, the receiver may further receive main signal error calculation results of the transmission lines from the opposed node device (DROP node 200), the delay controller may match phases of the path errors and the main signal error calculation results based on the relative phase difference, and the fault determiner may determine whether or not a fault has occurred based on the path errors and the main signal error calculation results in phase.

Namely, in FIG. 3, the ADD node 100 can determine a fault of the node itself based on the “relative phase difference”, the “path errors”, and the “main signal error calculation results” transmitted from the opposed DROP node 200.

In the ADD node 100, the receiver further receives the main signal error calculation results of the working transmission line and the protection transmission line from the opposed DROP node 200. The delay controller matches the phases of the relative phase difference, the main signal error calculation results, and the path errors.

The fault determiner determines whether or not a fault has occurred e.g. in its own node based on the output of the delay controller, i.e. both main signal error calculation results and both path errors in phase.

Namely, the fault determiner compares e.g. the both main signal error calculation results. It is possible to recognize that no error has occurred in the transmission line when the result=“match”, and that a fault has occurred in the working main signal transmitter (e.g. interface) of the node itself when the path error indicates “error”.

It is to be noted that the fault determiner can also determine whether or not a fault has occurred in the working transmission line or the protection transmission line.

When an error has already occurred in the main signal path inputted from the low-speed transmission line 600 in the ADD node 100, it is determined that a fault has occurred in the working low-speed interface 20_1. Therefore, when the path error is detected in the low-speed interface 20, it is required to remove the fault determination of the working low-speed interface 20_1.

(8) The present invention according to the above-mentioned invention may further comprise: a path error detector detecting an error on a low-speed transmission line side of the path; and a relative phase difference detector detecting, assuming the relative phase difference be made a first relative phase difference, a second relative phase difference indicating a relative phase difference between the low-speed transmission line side path error and the path error from the opposed node device (DROP node 200); the node device may further comprise, assuming the delay controller be made a first delay controller, a second delay controller matching the phases of the path errors from the opposed node device (DROP node 200) and from the low-speed transmission line side based on the second relative phase difference; and the fault determiner may determine whether or not a fault has occurred in the node itself based on the path errors in phase.

Namely, in FIG. 3, e.g. the ADD node 100 determines the fault of the node itself based on the “first relative phase difference” and the “path error” provided from the opposed DROP node 200, and the “second relative phase difference” and the “low-speed side path error” detected in the node itself.

The ADD node 100 is further provided with a path error detector, a relative phase difference detector, and a second delay controller. The path error detector detects the path error of the low-speed transmission line side of the same path as that of the working/protection transmission line.

The relative phase difference detector detects a second relative phase difference indicated by the relative phase difference between the low-speed transmission line side path error and the path errors from the DROP node 200. The second delay controller matches the phases of the path errors from the DROP node 200 and the low-speed transmission line side path errors based on the second relative phase difference.

The fault determiner determines whether or not a fault has occurred in its own node based on the path errors from the DROP node 200 and the low-speed transmission line side path errors.

When the low-speed transmission line side path error indicates “error”, the fault determiner determines that no fault occurs in the node itself.

Thus, the fault determiner can detect the fault of the ADD node or the transmission line with path error faults on the low-speed transmission line side being excluded in the same way as the above description.

(9) Also, in the present invention according to the above-mentioned invention, the receiver may further receive main signal error calculation results of the transmission lines from the opposed node device (DROP node 200), the first delay controller may match phases of the path errors and the main signal error calculation results based on the first relative phase difference, and a fault determiner may determine whether or not a fault has occurred in the node itself based on the path errors and the main signal error calculation results in phase.

Namely, e.g. the ADD node 100 determines a fault based on the “first relative phase difference”, the “path errors”, and the “main signal error calculation results” provided from the opposed DROP node 200, as well as the “second relative phase difference” and the “low-speed side path error” detected by the node itself.

In the ADD node 100, the receiver receives the “first relative phase difference”, the path errors, and the main signal error calculation results from the DROP node 200. The first delay controller matches the phases of the path errors and the main signal error calculation results based on the first relative phase difference.

The second delay controller matches the phase of the path errors on the low-speed transmission line side with that of the path errors from the DROP node 200 based on the second relative phase difference.

The fault determiner determines whether or not a fault has occurred in the node itself based on the path errors on the low-speed transmission line side, the path errors and the main signal error calculation results from the DROP node 200 in phase. When the low-speed transmission line side path error indicates “error”, the fault determiner determines that no fault occurs in e.g. the node itself.

Thus, the ADD node 100 is prevented from determining that a fault has occurred in the node itself based on the path error when an error has already occurred in the main signal path inputted from the low-speed transmission line side.

(10) Furthermore, a node device (e.g. ADD node 100) of the present invention comprises: a working interface and a protection interface receiving main signals from a low-speed transmission line; and a selector selecting either one of the main signals from the interfaces based on fault information transmitted from an opposed node device (e.g. DROP node 200).

### BRIEF DESCRIPTION OF THE DRAWINGS

The above and other objects and advantages of the invention will be apparent upon consideration of the following detailed description, taken in conjunction with the accompanying drawings, in which the reference numerals refer to like parts throughout and in which:

FIG. 1 is a block diagram showing an embodiment of an arrangement of a node device, specifically an ADD node according to the present invention;

FIG. 2 is a block diagram showing an embodiment of an arrangement of a node device, specifically a DROP node according to the present invention;

FIG. 3 is a diagram showing a processing operation of control information transmitted from an ADD node to a DROP node in a ring network using node devices (ADD node and DROP node) according to the present invention;

FIGS. 4A-4E are diagrams showing data examples of a multi-frame for obtaining a transmission delay in a ring network using a node device according to the present invention;

FIG. 5 is a diagram showing a processing operation of control information transmitted from a DROP node to an ADD node in a ring network using node devices (ADD node and DROP node) according to the present invention;

FIGS. 6A and 6B are diagrams showing multi-frame examples received by a node device (ADD node) according to the present invention;

FIGS. 7A-7G are diagrams showing determination examples of a fault determiner of an ADD node in an operational arrangement (1) of a node device according to the present invention;

FIGS. 8A and 8B are diagrams showing determination examples of a transmission line cycle-transmission delay amount in an operational embodiment (2) of a node device according to the present invention;

FIGS. 9E-9H are diagrams showing determination examples of a fault determiner of an ADD node in an operational embodiment (2) of a node device according to the present invention; and

FIG. 10 is a block diagram showing a general ring-shaped network composed of a prior art node device.

### DESCRIPTION OF THE EMBODIMENTS

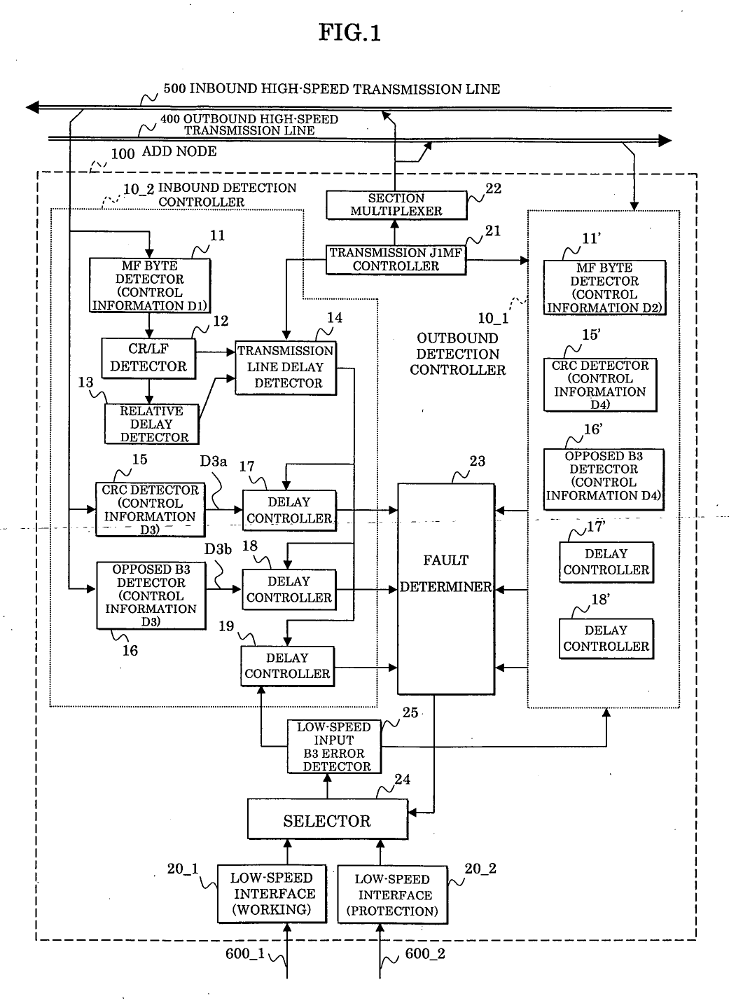

FIG. 1 shows an embodiment of a node device according to the present invention, and specifically of the ADD node 100 transmitting a main signal to an opposed node device. In this embodiment, only functional portions processing control signals which the ADD node 100 has received from a low-speed transmission line 600 and high-speed transmission lines 400 and 500 are shown, where functional portions processing a main signal are omitted.

The ADD node 100 is provided with an inbound detection controller 10_2 connected to the inbound high-speed transmission line 500, an outbound detection controller 10_1 connected to the outbound high-speed transmission line 400, a section multiplexer 22 connected to both of the high-speed transmission lines 400 and 500, a transmission J1MF controller 21 connected to the detection controllers 10_1 and 10_2 and the section multiplexer 22, a selector 24 connected to low-speed interfaces 20_1 and 20_2 (hereinafter, occasionally represented by a reference numeral 20), and a fault determiner 23 and a low-speed input B3 error detector 25 respectively connected to the detection controllers 10_1 and 10_2, and the selector 24.

The detection controller 10_2 is provided with an MF byte detector 11, a CRC detector 15, and an opposed B3 detector 16 respectively detecting a J1MF byte (J1 multi-frame byte), a CRC (Cyclic Redundancy Check) value, and a B3 byte from the inbound high-speed transmission line 500, a CR/LF detector 12 detecting “CR” and “LF” codes from the J1MF byte detected by the MF byte detector 11, and a relative delay detector 13 detecting an inbound/outbound relative delay from the detection result of the CR/LF detector 12.

Also, the inbound detection controller 10_2 is provided with; a transmission line delay detector 14 detecting a delay of a transmission line based on a signal from the transmission J1MF controller 21, the CR/LF detector 12, and the relative delay detector 13; and delay controllers 17-19 delaying signals detected at the CRC detector 15, the opposed B3 detector 16, and the low-speed input B3 error detector 25 by the detected transmission line delay amount to be provided to the fault determiner 23.

The arrangement of the outbound detection controller 10_1 is the same as that of the inbound detection controller 10_2 except that the MF byte detector 11′, the CRC detector 15′, and the opposed B3 detector 16′ respectively detect the J1MF byte, the CRC value, and the opposed B3 byte from the outbound high-speed transmission line 400.

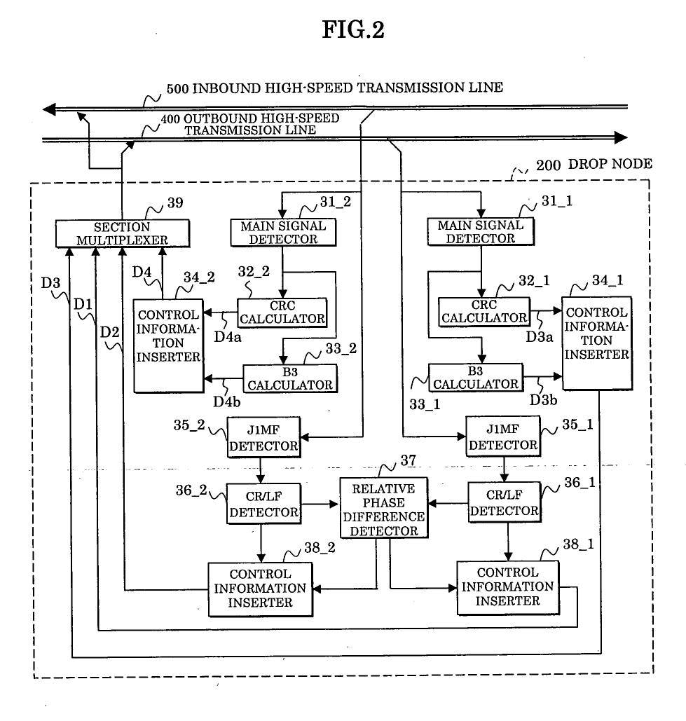

FIG. 2 shows an embodiment of a node device according to the present invention, and specifically of the DROP node 200 receiving main signals from the opposed node device (ADD node). In this embodiment, only functional portions processing the control signals received from the opposed node device are specifically shown, where functional portions processing the main signals are omitted.

The DROP node 200 is provided with a main signal detector 31_1 and a J1MF detector 35_1 respectively detecting the main signal and the J1MF byte from the outbound high-speed transmission line 400, a CRC calculator 32_1 and a B3 calculator 33_1 respectively calculating a CRC value D3a and a B3 byte D3b of the main signal detected, a control information inserter 34_1 inserting a CRC value D3a and a B3 byte D3b (hereinafter, CRC value D3a and B3 byte D3b are occasionally referred to as control information D3) calculated into an unused byte 3, and a CR/LF detector 36_1 detecting “CR”+“LF” code from the J1 multi-frame.

Also, the DROP node 200 is provided with a main signal detector 31_2, a J1MF detector 35_2, a CRC calculator 32_2, a control information inserter 34_2, a B3 calculator 33_2, and a CR/LF detector 36_2. Their functions are the same as those of the above-mentioned main signal detector 31_1, the J1MF detector 35_1, the CRC calculator 32_1, the control information inserter 34_1, the B3 calculator 33_1, and the CR/LF detector 36_1. However, different from the above description, the main signal detector 31_2 and the J1MF detector 35_2 respectively detect the main signal and the J1 multi-frame of the inbound high-speed transmission line 500 instead of the outbound high-speed transmission line 400, and the control information inserter 34_2 inserts a CRC value D4a and a B3 byte D4b (hereinafter, CRC value D4a and B3 byte D4b are occasionally referred to as control information D4) into an unused byte 4.

Furthermore, the DROP node 200 is provided with a relative phase difference detector 37 detecting a phase difference between the “CR”+“LF” detected at the CR/LF detector 36_1 and the “CR”+“LF” detected at the CR/LF detector 36_2, a control information inserter 38_1 inserting the “CR”+“LF” detected by the CR/LF detector 36_1 and the “phase difference” (hereinafter, “CR”+“LF”+“phase difference” is occasionally referred to as control information D1) into an unused MF byte 1, a control information inserter 38_2 inserting the “CR”+“LF” detected at the CR/LF detector 36_2 and the phase difference (hereinafter “CR”+“LF”+phase difference is occasionally referred to as control information D2) into an unused MF byte 2, and a section multiplexer 39 multiplexing the control information D1-D4 into a section.

### Operational Embodiment (1)

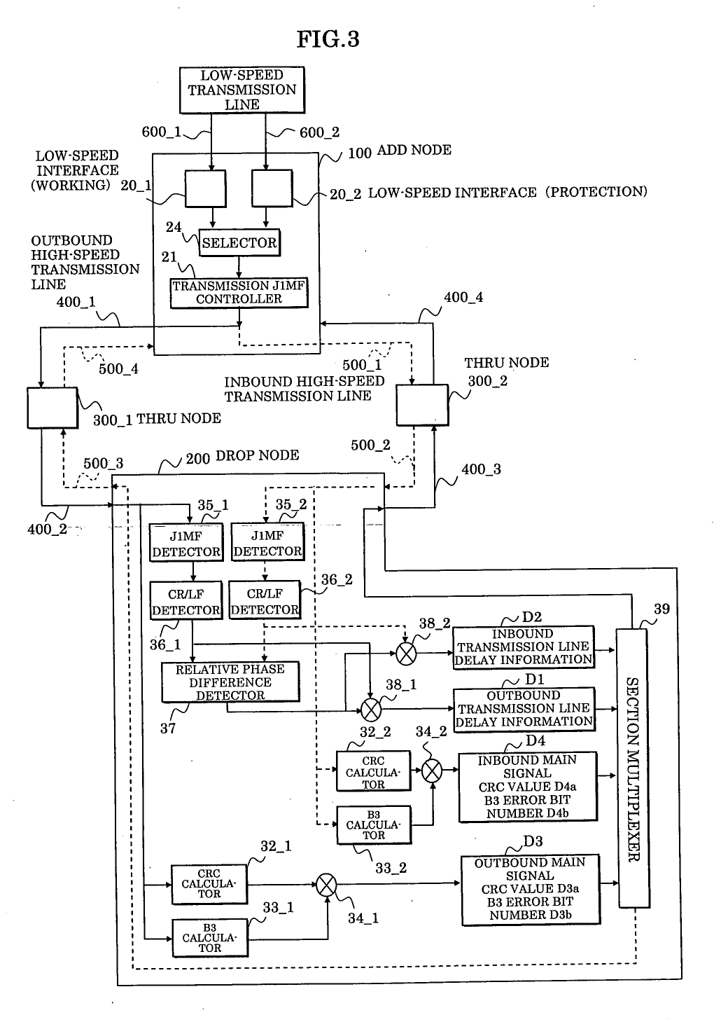

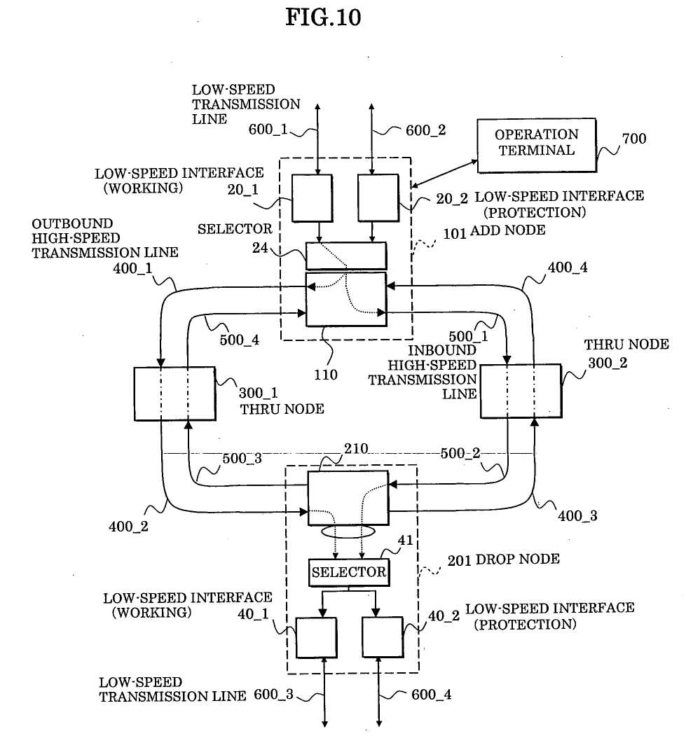

An operational embodiment (1) in a case where the ADD node 100 (see FIG. 1) and the DROP node 200 (see FIG. 2) of the present invention are applied to the network shown in FIG. 10 will now be described by referring to FIGS. 3, 4A-4E, 5, 6A and 6B, and 7A-7G.

FIG. 3 shows the flow of the control signal from the ADD node 100 to the DROP node 200.

In the ADD node 100, the working low-speed interface 20_1 and the protection low-speed interface 20_2 respectively provide the control signals received from low-speed transmission lines 600_1 and 600_2 to the selector 24. The selector 24 selects the control signal from the working low-speed interface 20_1 to be provided to the transmission J1MF controller 21.

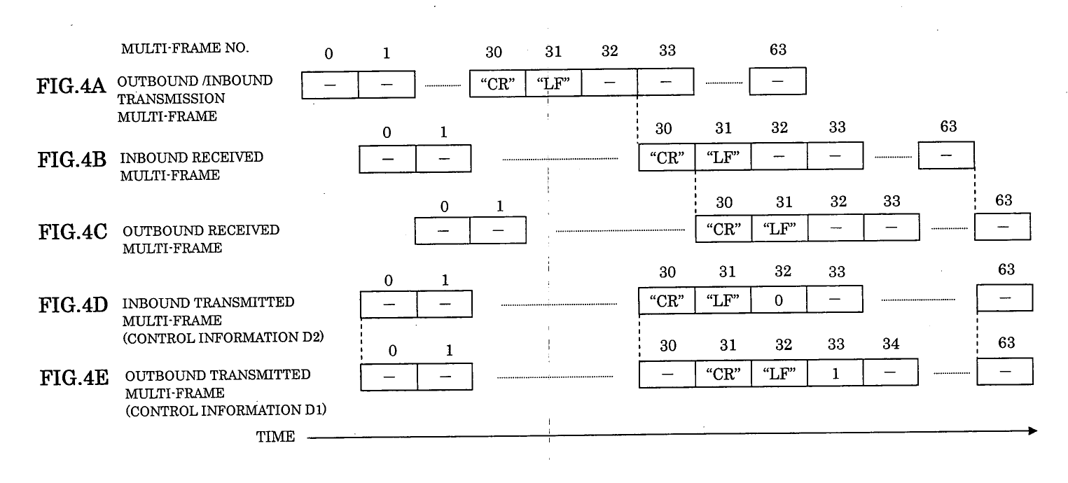

The transmission J1MF controller 21 prepares e.g. a J1 multi-frame of 64 frames. A “CR” code and an “LF” code are respectively inserted into the 30th frame and the 31st frame of the J1 multi-frame. FIG. 4A shows the J1 multi-frame prepared by the transmission J1MF controller 21.

The transmission J1MF controller 21 transmits the same multi-frames to the outbound high-speed transmission line 400 and the inbound high-speed transmission line 500.

In the DROP node 200, the J1MF detectors 35_1 and 35_2 respectively extract the J1 multi-frames included in the main signal paths received from the high-speed transmission lines 400 and 500. The CR/LF detectors 36_1 and 36_2 detect the “CR” and the “LF” inserted into the J1 multi-frames.

FIGS. 4B and 4C show the J1 multi-frames respectively extracted by the J1MF detectors 35_2 and 35_1, and a reception timing example of the “CR” and “LF” inserted thereinto.

Since the transmission delay in the outbound high-speed transmission line 400 is different from that in the inbound high-speed transmission line 500, the outbound “CR” code and the “LF” code in FIG. 4C are received with 1 frame behind the inbound “CR” code and the “LF” code in FIG. 4B.

The relative phase difference detector 37 obtains the outbound-to-inbound relative phase difference. Namely, the detector 37 detects how late the outbound “CR” code and the “LF” code are received with reference to the inbound “CR” code and the “LF” code earlier received.

The control information inserters 38_1 and 38_2 respectively copy the J1 multi-frame byte extracted by the J1MF detectors 35_1 and 35_2 to an unused multi-frame byte (inbound phase difference information) and an unused multi-frame byte (outbound phase difference information) per frame, and multiplex the relative phase difference information detected by the relative phase difference detector 37 into e.g. subsequent frame (frame No. 32) of the “CR” and “LF”.

FIGS. 4D and 4E show examples of an inbound frame and an outbound frame into which the phase difference information is inserted, where “0” and “1” are respectively inserted into the frame No. 32. Hereinafter, the inbound/outbound transmission line delay information respectively shown in FIGS. 4D and 4E is occasionally referred to as control information D2 and D1.

The CRC calculator 32_1 and the B3 calculator 33_1 respectively calculate the CRC value D3a and the error bit number D3b of the B3 byte of the main signal received from the outbound high-speed transmission line 400. The control information inserter 34_1 inserts the CRC value D3a and the B3 error bit number D3b into the control information D3.

Similarly, the CRC calculator 32_2 and the B3 calculator 33_2 respectively calculate the CRC value D4a and the error bit number D4b of the B3 byte of the main signal received from the inbound high-speed transmission line 500, and the control information inserter 34_2 inserts the CRC value D4a and the B3 error bit number D4b into the control information D4.

The section multiplexer 39 multiplexes the control information D1 and D2 into an unused byte of the multi-frame, and transmits signals in which the control information D3 and D4 is multiplexed into the unused byte to the outbound high-speed transmission line 400 and the inbound high-speed transmission line 500.

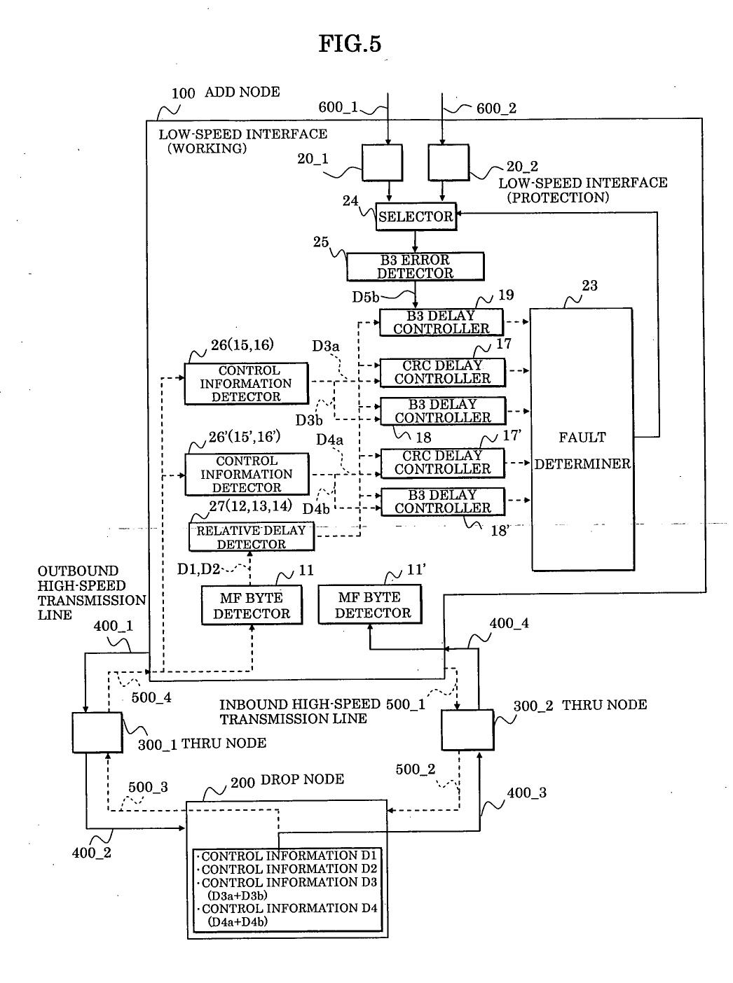

FIG. 5 shows an operation in which the control information D1-D4 is transmitted from the DROP node 200 (see FIG. 2) to the ADD node 100 (see FIG. 1) and processed at the ADD node 100.

The control information D1-D4 is transmitted from the DROP node 200 to the ADD node 100 through the outbound high-speed transmission lines 400_3 and 400_4 and the inbound high-speed transmission lines 500_3 and 500_4.

In the ADD node 100, the MF byte detectors 11 and 11′ respectively receive the control information D1-D4 from the inbound high-speed transmission line 500 and the outbound high-speed transmission line 400.

In the ADD node 100, it is possible to perform a delay control and data processing based on the control information D1-D4 received by one of the MF byte detectors 11 and 11′.

In FIG. 5, the MF byte detector 11 performs the data control and the data processing to the control information D1-D4 received from the inbound high-speed transmission line 500.

A relative delay detector 27, corresponding to detectors 12-14 in FIG. 1, detects the control information D1 and D2, and extracts the relative phase (delay time) difference between the inbound high-speed transmission line 500 and the outbound high-speed transmission line 400 based on the control information D1 and D2.

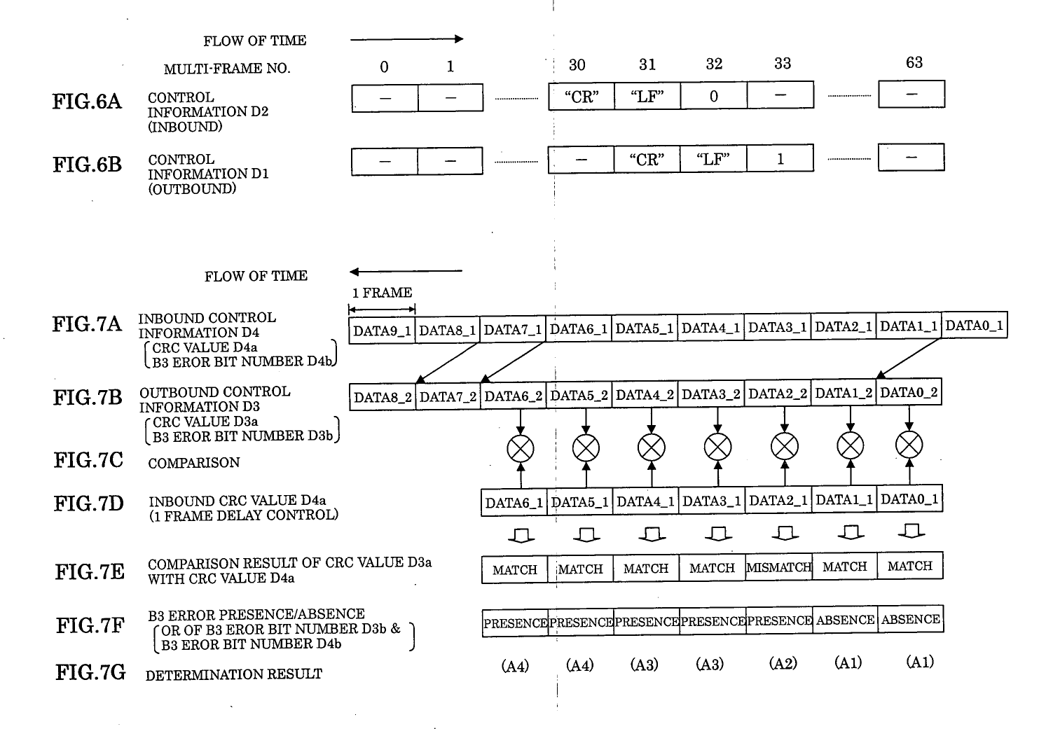

FIGS. 6A and 6B show the control information D2 and D1 respectively received by the relative delay detector 27. The relative delay detector 27 is provided with a scale-of-64 counter (not shown) which counts the multi-frame Nos., and extracts the inbound J1 bytes=“CF”, “LF”, and “phase difference information between the inbound and the outbound=0” at the timings of the count Nos.=“30”, “31”, and “32”.

The relative delay detector 27 recognizes that the inbound main signal has arrived at the DROP node 200 earlier than the outbound main signal because the phase difference information=“0”.

It is to be noted that while the scale-of-64 counter is a free-running counter and the count No. (multi-frame No. in FIGS. 6A and 6B) is irrelevant to the multi-frame No. of the DROP node 200, FIGS. 6A and 6B show a case where the count No. is the same as the multi-frame No. of the DROP node 200.

Also, the relative delay detector 27 extracts the outbound J1 bytes=“CR”, “LF”, and “phase difference information between inbound and outbound=1” at the timing of the multi-frame Nos.=“31”, “32”, and “33”.

Thus, the relative delay detector 27 recognizes that the outbound main signal has arrived at the DROP node 200 later than the inbound main signal, and the difference (relative phase difference) therebetween is 1 frame.

A control information detector 26, corresponding to the CRC detector 15 and the opposed B3 detector 16 in FIG. 1, detects the control information D3 (“outbound CRC value D3a”+“outbound B3 error bit number D3b”), and provides the “CRC value D3a” and the “B3 error bit number D3b” to the CRC delay controller 17 and the B3 delay controller 18, respectively.

The CRC delay controller 17 and the B3 delay controller 18 respectively provide the “outbound CRC value” and the “outbound B3 error bit number” to the fault determiner 23 without a delay control.

Similarly, a control information detector 26′, corresponding to CRC detector 15′ and opposed B3 detector 16′ of FIG. 1, detects the control information D4 (“inbound CRC value D4a”+“inbound B3 error bit number D4b”), and provides the “inbound CRC value D4a”+the “inbound B3 error bit number D4b” to a CRC delay controller 17′ and a B3 delay controller 18′, respectively.

The CRC delay controller 17′ and the B3 delay controller 18′ respectively provide the “inbound CRC value D4a” and the “inbound B3 error bit number D4b” to the fault determiner 23 after performing a delay control for 1 frame.

Thus, the phase differences between the “outbound CRC value D3a” and the “outbound B3 error bit number D3b”, and the “inbound CRC value D4a” and the “inbound B3 error bit number D4b” are eliminated.

FIGS. 7A-7G show a delay control in the delay controllers 17, 17′, 18, 18′, and the determination of the fault determiner 23.

FIG. 7A shows the control information D4 (inbound CRC value D4a and inbound B3 error bit number D4b) included in data DATA0_1-DATA9_1. FIG. 7B shows the control information (outbound CRC value D3a and outbound B3 error bit number D3b) D3 included in data DATA0_2-DATA8_2.

The fault determiner 23 receives the control information D4 shown in FIG. 7D that is the control information D4 of FIG. 7A to which the delay control for 1 frame is performed, and receives the control information D3 without performing the delay control. Thus, it becomes possible for the fault determiner 23 to indirectly compare the same main signals (in-phase where the delay difference (phase difference) between the outbound high-speed transmission line 400 and the inbound high-speed transmission line 500 is absorbed) at a time of reaching the DROP node 200 based on the CRC value.

FIG. 7E shows a comparison result (“match” or “mismatch”) of the outbound CRC value D3a with the inbound CRC value D4a. FIG. 7F shows a presence/absence (logical sum=“0: absence of error”, “except 0: presence of error”) determined based on the logical sum calculation result between “the outbound B3 error bit number D3b” and “the inbound B3 error bit number D4b”.

FIG. 7G shows determination results (A1)-(A4) when the fault determiner 23 performs the fault determination based on the comparison result of FIG. 7E and the determination result of FIG. 7F.
(A1): Determine “comparison results in match” & “absence of error”=“source is normal” and “transmission line is normal”
(A2): Determine “comparison results in mismatch” & “presence of error”=“fault occurrence in the outbound high-speed transmission line 400 or the inbound high-speed transmission line 500”→supported by a prior art ring switchover
(A3): Determine “comparison results in match” & “presence of error”=“working low-speed interface 20_1 is abnormal” (during protection time: protection stage number=“3” is set in this embodiment)
(A4): Determine “comparison results in match” & “presence of error”=“package of ADD node 100 is abnormal” (protection time elapses)→control selector 24 to switch over the working low-speed interface 20_1 to the protection low-speed interface 20_2

### Operational Embodiment (2)

In the above-mentioned embodiment (1), whether or not a main signal error has already occurred in the ADD node 100 side and whether or not an error has occurred by a fault of the high-speed transmission line are determined. Based on this determination result, either the switchover between the low-speed interfaces 20_1 and 20_2 of the ADD node 100 or the switchover between the high-speed transmission lines 400 and 500 is performed.

However, when an error has already occurred in the main signal inputted from the low-speed transmission line 600 in the ADD node 100, it is determined to be faults of the working low-speed interface 20_1 and the protection low-speed interface 20_2 after the switchover, so that the switchover operation for the low-speed interface 20 in which no fault has occurred is to be repeated.

Accordingly, when an error has occurred in the main signal inputted from the low-speed transmission line 600, it is required to suppress the switchover of the low-speed interface 20 without determining a fault of the low-speed interface 20.

Hereinafter, the operation in which the fault determiner 23 suppresses the switchover of the working low-speed interface 20 when an error has occurred in the main signal of the low-speed transmission line 600 will be described.

In FIG. 5, the low-speed input B3 error detector 25 calculates B3 of the main signal inputted from the low-speed transmission line 600, and detects a low-speed B3 error bit number D5b.

The relative delay detector 27 detects a ring cycle delay amount, and provides this delay amount to the B3 delay controller 19. The B3 delay controller 19 performs a delay control to the low-speed B3 error bit number D5b so as to provide the same timing, i.e. the same frame information as the other “CRC values D3a and D4a”, and “B3 error bit numbers D3b and D4b” to be provided to the fault determiner 23.

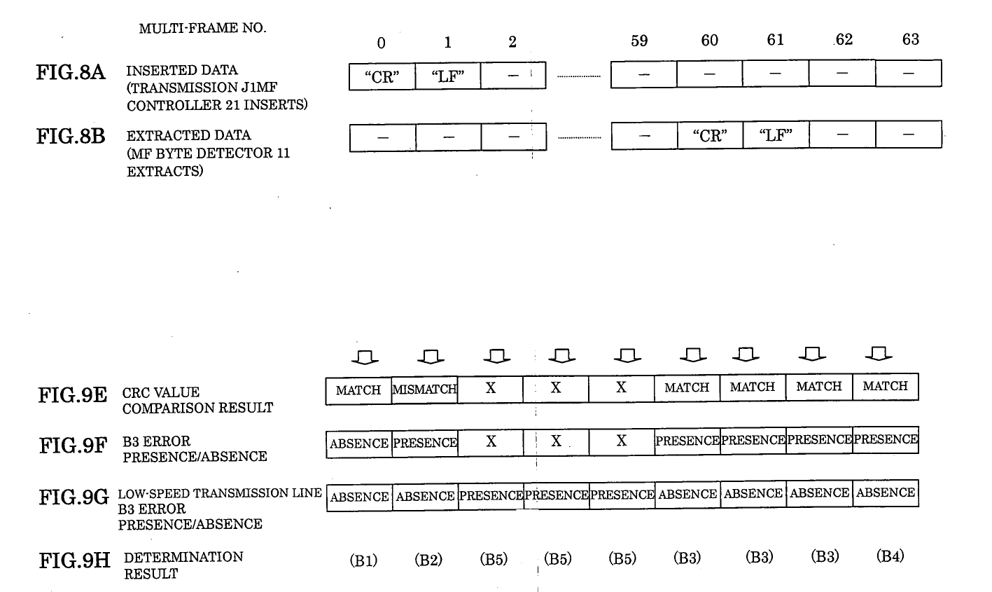

FIG. 8A shows a timing when the transmission J1MF controller 21 (see FIG. 1) in the ADD node 100 inserts the data “CR”+“LF” into the inbound high-speed transmission line 500 through the section multiplexer 22. This timing is notified to the transmission delay detector 14 from the transmission J1MF controller 21.

FIG. 8B shows a timing when the CR/LF detector 12 (see FIG. 1) extracts the data “CR”+“LF” returned after having gone round the inbound high-speed transmission line (ADD node 100→DROP node 200→ADD node 100) 500 through the MF byte detector 11. This timing is also notified to the transmission line delay detector 14 from the CR/LF detector 12.

The transmission line delay detector 14 can determine a cycle transmission delay time (phase difference) of the inbound high-speed transmission line 500 by comparing the two timings. Namely, it is recognized that a cycle transmission delay amount=61-1=60 frames.

By performing the subsequent delay control based on this cycle transmission delay amount, it becomes possible to compare the B3 error bit numbers of the same main signal component when they are received by the ADD node 100 and the DROP node 200.

For example, when the control information D2 (inbound information phase difference)=0 frame, and the control information D1 (outbound information phase difference)=1 frame, a delay control for “1” frame of the outbound control information D1 is further required. Therefore, the B3 delay controller 19 performs a delay control for “60 frames (for a ring cycle)+1 frame” to the “low-speed B3 error bit number D5b”.

Furthermore, in the same way as the embodiment (1), by performing the following delay controls (1)-(4), all of the information can be treated as the same main signal frame information.

(1) Delay for 1 frame to the inbound CRC value, (2) Delay for 1 frame to the inbound B3 error bit number, (3) No delay to the outbound CRC value, and (4) No delay to the outbound B3 error bit number.

It is to be noted that on the contrary when the control information D2 (inbound information phase difference)=1 frame, and the control information D1 (outbound information phase difference)=0 frame, the following delay controls (1)-(5) are performed.

(1) No delay control to the inbound CRC value, (2) No delay control to the inbound B3 error bit number, (3) Delay control for 1 frame to the outbound CRC value, (4) Delay control for 1 frame to the outbound B3 error bit number, and (5) Delay control for 60 frames to the low-speed B3 error bit number of the ADD node.

FIGS. 9E and 9F respectively correspond to FIGS. 7E and 7F of the embodiment (1), showing the CRC value comparison result (match, mismatch, or don't care=X) and the presence/absence of B3 error (presence, absence, or don't care=X) after performing the delay control to the control information D3 and D4 shown in FIGS. 7A-7D. FIG. 9H shows the presence/absence of the low-speed B3 error bit number.

FIG. 9I shows determination results (B1)-(B5) of the fault determiner 23 based on the FIGS. 9E, 9F and 9H. The determination results (B1)-(B5) will now be described.
(B1): “Comparison results in match” & “absence of error” & “absence of low-speed error”=source is normal and transmission line is normal
(B2): “Comparison results in mismatch” & “presence of error” & “absence of low-speed error”=a fault occurs in either of the outbound high-speed transmission line 400 or the inbound high-speed transmission line 500→supported by the prior art ring switchover
(B3): “Comparison results in match” & “presence of error ERR” & “absence of low-speed error”=working low-speed interface 20_1 is determined to be abnormal (during protection time: protection stage number=“3” is set in this embodiment (2))
(B4): “Comparison results in match” & “presence of error” & “absence of low-speed error”=working low-speed interface 20_1 is determined to be abnormal (protection time elapses) →save the main signal by switching over the working low-speed interface 20_1 to the protection low-speed interface 20_2 with the selector 24
(B5): “Presence of low-speed error”=It is determined that an error has already occurred on the low-speed transmission line 600, so that the fault determination and the switchover by the selector 24 are not performed.

As described above, the node device according to the present invention is arranged such that a relative phase difference detector detects a relative phase difference between a transmission delay of a working transmission line and that of a protection transmission line, a path error detector detects path errors through the transmission lines, and one of mutually opposed node devices detects a fault based on the path errors made in phase based on the relative phase difference. Therefore, it becomes possible to determine whether or not a fault has occurred in the working transmission line, the protection transmission line or the node device itself.

Also, a main signal error calculator calculates errors of main signals from the working transmission line and the protection transmission line, whereby it becomes possible to determine whether or not a fault has occurred in the working transmission line, the protection transmission line or the node device itself based on the calculation results and the path errors made in phase by the relative phase difference.

Also, the path error of the low-speed transmission line side is compared with that of the working high-speed transmission line and that of the protection high-speed transmission line in phase. Therefore, a path error which has occurred in the low-speed transmission line side is not misidentified as a path error which has occurred on the node device side or the high-speed transmission line side.

In a case where a main signal abnormality occurs intermittently in a DROP node by a fault of a package on an ADD node side in a network of a ring switchover system for example, it becomes possible to distinguish the main signal error due to the fault of the ADD node from that due to a quality deterioration of the transmission line.

Thus, it becomes possible to save the main signal by switching over the abnormal package on the ADD node side in a case where the main signal can not be saved even if the main signal path is switched over (ring switching) in the conventional technology, thereby improving the transmission quality.

1. A node device comprising:
a relative phase difference detector receiving main signals simultaneously transmitted from an opposed node device to a working transmission line and a protection transmission line and detecting a relative phase difference between both of the main signals;
a path error detector detecting path errors on the transmission lines; and
a transmitter transmitting the relative phase difference and the path errors to the opposed node device.

2. The node device as claimed in claim 1, further comprising a main signal error calculator calculating errors of the main signals from the working transmission line and the protection transmission line,
the transmitter transmitting the relative phase difference, the path errors and main signal error calculation results to the opposed node device.

3. A node device comprising:
a relative phase difference detector receiving main signals simultaneously transmitted from an opposed node device to a working transmission line and a protection transmission line and detecting a relative phase difference between both of the main signals;
a path error detector detecting path errors on the transmission lines;
a fault detector detecting a fault based on the relative phase difference and the path errors; and
a transmitter notifying the fault to the opposed node device.

4. The node device as claimed in claim 3, further comprising a main signal error calculator calculating errors of the main signals from the transmission lines,
the fault detector detecting the fault based on the relative phase difference, the path errors and main signal error calculation results and the transmitter notifying the fault to the opposed node device.

5. The node device as claimed in claim 1, wherein the transmitter transmits the relative phase difference by using an unused portion of a path overhead.

6. A node device comprising:
a receiver receiving a relative phase difference between a working transmission line and a protection transmission line transmitted from an opposed node device and path errors on the transmission lines;
a delay controller matching phases of the path errors based on the relative phase difference; and
a fault determiner determining whether or not a fault has occurred in the node itself based on the path errors in phase.

7. The node device as claimed in claim 6, wherein the receiver further receives main signal error calculation results of the transmission lines from the opposed node device, the delay controller matches phases of the path errors and the main signal error calculation results based on the relative phase difference, and the fault determiner determines whether or not a fault has occurred based on the path errors and the main signal error calculation results in phase.

8. The node device as claimed in claim 6, further comprising:
a path error detector detecting an error on a low-speed transmission line side of the path; and
a relative phase difference detector detecting, assuming the relative phase difference be made a first relative phase difference, a second relative phase difference indicating a relative phase difference between the low-speed transmission line side path error and the path error from the opposed node device;
the node device further comprising, assuming the delay controller be made a first delay controller, a second delay controller matching the phases of the path errors from the opposed node device and from the low-speed transmission line side based on the second relative phase difference;
the fault determiner determining whether or not a fault has occurred in the node itself based on the path errors in phase.

9. The node device as claimed in claim 8, wherein the receiver further receives main signal error calculation results of the transmission lines from the opposed node device, the first delay controller matches phases of the path errors and the main signal error calculation results based on the first relative phase difference, and a fault determiner determines whether or not a fault has occurred in the node itself based on the path errors and the main signal error calculation results in phase.

10. A node device comprising:
a working interface and a protection interface receiving main signals from a low-speed transmission line; and
a selector selecting either one of the main signals from the interfaces based on fault information transmitted from an opposed node device.
